(19) United States
(12) Patent Application Publication
(10) Pub. No.: US 2026/0189962 A1
(43) Pub. Date: Jul. 2, 2026

(54) METHOD AND APPARATUS FOR INTERFERENCE MITIGATION IN COMMUNICATION SYSTEM

(71) Applicant: ELECTRONICS AND TELECOMMUNICATIONS RESEARCH INSTITUTE, Daejeon (KR)

(72) Inventors: Chang-Sik CHOI, Seoul (KR); Bon Jun KU, Daejeon (KR); Hee Wook KIM, Daejeon (KR); Dae Sub OH, Daejeon (KR)

(73) Assignee: ELECTRONICS AND TELECOMMUNICATIONS RESEARCH INSTITUTE, Daejeon (KR)

(21) Appl. No.: 19/435,191

(22) Filed: Dec. 29, 2025

(30) Foreign Application Priority Data
Jan. 2, 2025 (KR) 10-2025-0000534

(51) Int. Cl. H04W 24/10

(52) U.S. Cl. CPC H04W 24/10

(57) ABSTRACT

A method of a core network entity may comprise: generating first measurement configuration information for resource blocks predicted to be used by a satellite; transmitting the first measurement configuration information to a plurality of base stations; receiving first measurement results from the plurality of base stations, the first measurement results being measured for the resource blocks according to the first measurement configuration information; and estimating at least one resource block used by the satellite based on the received first measurement results.

### CROSS-REFERENCE TO RELATED APPLICATIONS

This application claims priority to Korean Patent Application No. 10-2025-0000534, filed on Jan. 2, 2025, with the Korean Intellectual Property Office (KIPO), the entire contents of which are hereby incorporated by reference.

### BACKGROUND

### 1. Technical Field

The present disclosure relates to an interference mitigation technique in a communication system, and more particularly, to an interference mitigation technique for channel in a communication system, which allows a base station to detect an interference of a non-terrestrial network and to mitigate the detected interference.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

The communication network may be a terrestrial network that can provide communication services to terminals located on the ground (terrestrial sites). Recently, the demand for communication services not only for ground-based devices but also for unmanned aerial vehicles and satellites located in non-terrestrial space has been increasing, and technologies for non-terrestrial networks (NTNs) are being discussed in 3GPP to support such services. A cell of a non-terrestrial network (i.e. non-terrestrial cell) may be relatively large compared to a cell of a terrestrial network (i.e. terrestrial cell). Accordingly, a terrestrial cell may geographically exist within a non-terrestrial cell. When the terrestrial cell and the non-terrestrial cell coexist in the same frequency, the terrestrial cell may require technologies capable of mitigating interference arriving from satellite networks.

### SUMMARY

The present disclosure for resolving the above-described problems is directed to providing an interference mitigation method and apparatus in a communication system, which allow a base station to detect an interference of a non-terrestrial network and to mitigate the detected interference.

According to a first exemplary embodiment of the present disclosure, a method of a core network entity may comprise: generating first measurement configuration information for resource blocks predicted to be used by a satellite; transmitting the first measurement configuration information to a plurality of base stations; receiving first measurement results from the plurality of base stations, the first measurement results being measured for the resource blocks according to the first measurement configuration information; and estimating at least one resource block used by the satellite based on the received first measurement results.

The first measurement configuration information may include at least one of: information on a measurement frequency band of satellite signals of the satellite, information on a measurement start time of the satellite signals, information on a measurement duration of the satellite signals, information on a number of measurements within the measurement duration, or a flag designation condition.

Each of the first measurement results may include an average received signal strength obtained by averaging received signal strengths measured by each of the plurality of base stations for each of the resource blocks at a predetermined time and with a predetermined number of measurements.

The method may further comprise, before the generating of the first measurement configuration information, generating second measurement configuration information for the resource blocks predicted to be used by the satellite; transmitting the second measurement configuration information to a representative base station representing the plurality of base stations; and receiving a second measurement result from the representative base station, the second measurement result being measured for the resource blocks according to the second measurement configuration information.

The second measurement configuration information may include at least one of: information on a measurement frequency band of satellite signals of the satellite, information on a measurement start time of the satellite signals, information on a measurement period of the satellite signals, information on a number of measurements in the measurement period, or an interference reporting threshold.

The estimating of the at least one resource block may comprise: identifying average received signal strengths equal to or greater than an interference estimation threshold from among average received signal strengths included in the received first measurement results; identifying resource blocks corresponding to the identified average received signal strengths; identifying, for each of the identified resource blocks, a number of base stations having average received signal strengths equal to or greater than the interference estimation threshold; and estimating, as the at least one resource block used by the satellite, a resource block for which the number of base stations is equal to or greater than a threshold number.

The method may further comprise: transmitting information on the at least one resource block used by the satellite to the plurality of base stations.

The method may further comprise: identifying a movement path of the satellite based on the at least one resource block used by the satellite; and transmitting information on the at least one resource block to base stations located along the identified movement path.

The method may further comprise: generating third measurement configuration information for the at least one resource block; transmitting the third measurement configuration information to the base stations located along the movement path; receiving third measurement results from the base stations located along the movement path, the third measurement results being measured for the at least one resource block according to the third measurement configuration information; identifying, based on the received third measurement results, at least one base station located outside the movement path; and instructing the at least one base station to use the at least one resource block.

According to a second exemplary embodiment of the present disclosure, a method of a base station may comprise: receiving, from a core network entity, first measurement configuration information for resource blocks predicted to be used by a satellite; performing measurement on the resource blocks predicted to be used by the satellite according to the first measurement configuration information; and transmitting a measurement result obtained from the measurement to the core network entity.

The first measurement configuration information may include at least one of: information on a measurement frequency band of satellite signals of the satellite, information on a measurement start time of the satellite signals, information on a measurement duration of the satellite signals, information on a number of measurements within the measurement duration, or a flag designation condition.

Each of the first measurement results may include an average received signal strength obtained by averaging received signal strengths measured by each of the plurality of base stations for each of the resource blocks at a predetermined time and with a predetermined number of measurements.

The method may further comprise, based on the base station being a representative base station representing a plurality of base stations located nearby, before the receiving of the first measurement configuration information, receiving, from the core network entity, second measurement configuration information for the resource blocks predicted to be used by the satellite; performing measurement on the resource blocks predicted to be used by the satellite according to the second measurement configuration information; and transmitting a second measurement result obtained from the measurement to the core network entity.

The second measurement configuration information may include at least one of: information on a measurement frequency band of satellite signals of the satellite, information on a measurement start time of the satellite signals, information on a measurement period of the satellite signals, information on a number of measurements in the measurement period, or an interference reporting threshold.

The method may further comprise: receiving, from the core network entity, information on at least one resource block used by the satellite.

The method may further comprise: receiving, from the core network entity, third measurement configuration information for the at least one resource block; performing measurement on the at least one resource block used by the satellite according to the third measurement configuration information; and transmitting a third measurement result obtained from the measurement to the core network entity.

According to a third exemplary embodiment of the present disclosure, a base station may comprise at least one processor, and the at least one processor may cause the base station to perform: receiving, from a core network entity, first measurement configuration information for resource blocks predicted to be used by a satellite; performing measurement on the resource blocks predicted to be used by the satellite according to the first measurement configuration information; and transmitting a measurement result obtained from the measurement to the core network entity.

Based on the base station being a representative base station representing a plurality of base stations located nearby, the at least one processor may cause the base station to perform, before the receiving of the first measurement configuration information, receiving, from the core network entity, second measurement configuration information for the resource blocks predicted to be used by the satellite; performing measurement on the resource blocks predicted to be used by the satellite according to the second measurement configuration information; and transmitting a second measurement result obtained from the measurement to the core network entity.

The at least one processor may further cause the base station to perform: receiving, from the core network entity, information on at least one resource block used by the satellite. The at least one processor may further cause the base station to perform: receiving, from the core network entity, third measurement configuration information for the at least one resource block; performing measurement on the at least one resource block used by the satellite according to the third measurement configuration information; and transmitting a third measurement result obtained from the measurement to the core network entity.

According to the present disclosure, terrestrial base stations can receive downlink signals from a satellite and identify radio resources used by the satellite. The terrestrial base stations can then deliver information on the identified radio resources to a core network entity. Accordingly, the core network entity can receive the information from the terrestrial base stations and predict interference. The core network entity can enable other terrestrial base stations located along a movement path (or trajectory) of the satellite to recognize the radio resources used by the satellite. As a result, the terrestrial base stations can avoid interference from the low Earth orbit (LEO) satellite.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a sequence diagram illustrating exemplary embodiments of a method for triggering interference measurement in a communication system.

FIG. 5 is a sequence diagram illustrating exemplary embodiments of an interference mitigation method in a communication system.

FIG. 6 is a conceptual diagram illustrating a format of a measurement report message.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHZ. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks (e.g. 4G communication network, 5G communication network, and/or 6G communication network). Here, the communication network may be used in the same sense as the communication system.

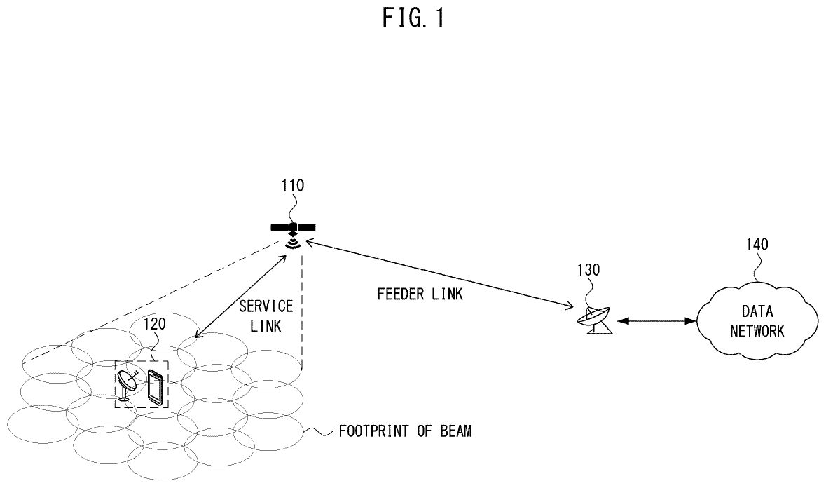

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located in non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology, NR, and/or 6G technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE, NR, and/or 6G specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR and/or 6G technology. The communications between the gateway 130 and the base station may be performed based on an NR-Uu interface and/or 6G interface, and the communications between the base station and the core network (e.g. AMF, UPF, SMF, and the like) may be performed based on an NG-C/U interface and/or 6G interface.

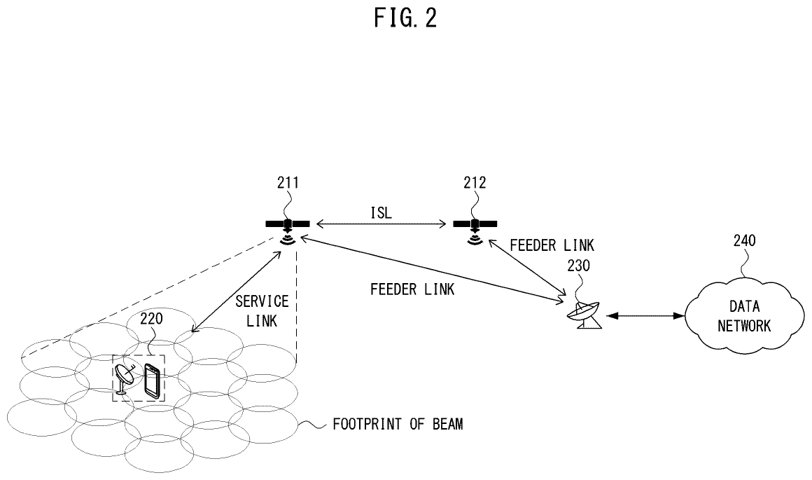

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a “core network” between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

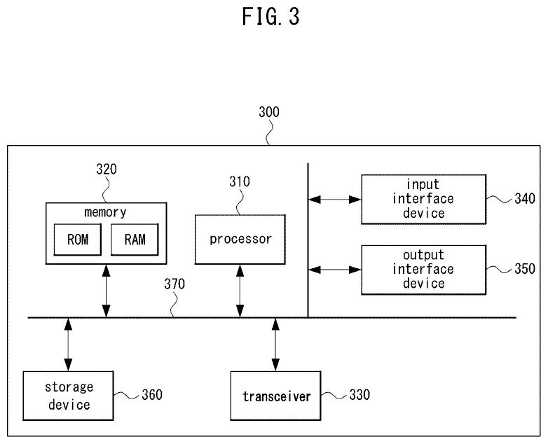

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown | NTN shown |
|---|---|---|
| | in FIG. 1 | in FIG. 2 |
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum (service link) | <6 GHz (e.g. 2 GHz) | | |
| | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance between | 40,581 | km | 1,932 km (altitude of 600 km) |
| satellite and communication | | | 3,131 km (altitude of 1,200 km) |
| node (e.g. UE) at the | | | |
| minimum elevation angle | | | |
| Maximum round trip delay | Scenario A: 541.46 ms | | Scenario C: (transparent |
| (RTD) | (service and feeder links) | | payload: service and feeder |
| (only propagation delay) | Scenario B: 270.73 ms | | links) |
| | (only service link) | | −5.77 ms (altitude of 60 0 km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |
| within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | | Scenario D1-2 | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface between | (worst case) | | | | | |
| base station and UE | | | | | | |
| Minimum RTD in a | 477.14 ms | 238.57 ms | 8 | ms | 4 | ms |
| radio interface between | | | | | | |
| base station and UE | | | | | | |

Meanwhile, a cell of a non-terrestrial network (i.e. non-terrestrial cell) may be relatively large compared to a cell of a terrestrial network (i.e. terrestrial cell). Accordingly, a terrestrial cell may locally exist within a non-terrestrial cell. In this case, the terrestrial cell and the non-terrestrial cell may use the same frequency band. In such a case, the non-terrestrial network may cause interference to the terrestrial network. In other words, signals of a frequency band used in the non-terrestrial network to communicate with terrestrial terminals may cause interference to communication between a base station and a terminal of the terrestrial network.

In an environment in which a non-geostationary orbit (NGSO) satellite network and a terrestrial network coexist, frequency interference may occur when frequency resources used by the terrestrial network are also used by the satellite network. When the number of satellites in the non-geostationary orbit satellite network is small, frequency interference to the terrestrial network may not be large. As the number of satellites in the non-geostationary orbit satellite network increases, more radio resources may be utilized by the satellites. In this case, downlink signals of the satellite network may cause large interference to a terminal located on the ground and receiving signals in the same frequency band.

When the non-geostationary orbit satellite network intends to utilize specific radio resources, the non-geostationary orbit satellite network may provide information indicating that the non-geostationary orbit satellite network is to use the radio resources to the terrestrial network. However, as the number of satellites increases, the satellites may also perform frequency reuse. In such a situation, due to characteristics of the satellite network in which the number of satellites existing in orbit changes over time, the non-geostationary orbit satellite network may fail to accurately provide to the terrestrial network information regarding which frequency-time radio resources are used.

The present disclosure is directed to enabling a core network entity to acquire information on interference patterns from terrestrial base stations when frequency resources used by a satellite network for communication with a terrestrial terminal cause interference to communication between a terrestrial base station and a terminal in a terrestrial network, and to improve communication performance of the terrestrial network by utilizing such interference patterns.

In the present disclosure, terrestrial base stations may receive downlink signals and identify radio resources used by a satellite. Specifically, according to the present disclosure, the terrestrial base stations and a core network entity may detect interference of radio resources for a sufficient time. The core network entity may accurately identify the radio resources used by the satellite based on such interference information. The core network entity may enable other terrestrial base stations located along a movement path of the satellite to identify the radio resources used by the satellite. As a result, the terrestrial base stations may avoid frequency interference caused by low-earth-orbit satellites.

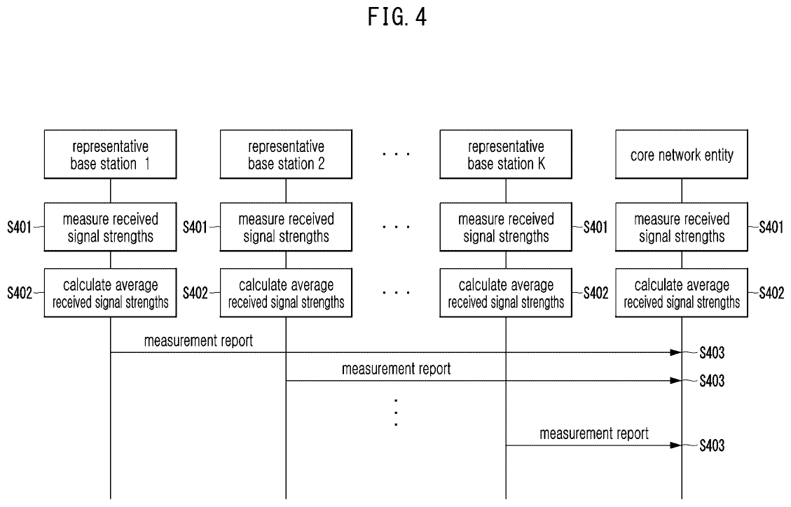

FIG. 4 is a sequence diagram illustrating exemplary embodiments of a method for triggering interference measurement in a communication system.

Referring to FIG. 4, a core network entity may generate interference measurement configuration information for triggering interference measurement, including a satellite signal measurement frequency band, a satellite signal measurement start time, a satellite signal measurement period, a number of measurements in a period, an interference reporting threshold, and other related parameters. Here, the satellite signal measurement frequency band may be a frequency band used by terrestrial base stations. The satellite signal measurement start time may be a specific time based on a reference time (e.g. YYYY-MM-DD HH: MM: SS). The satellite signal measurement period may be, for example, 10 seconds. The number of measurements in a period may be, for example, 5. The interference reporting threshold may be, for example, 60 dB.

The core network entity may transmit the generated interference measurement configuration information for triggering interference measurement to representative base stations (e.g. base stations 1 to K) capable of representing terrestrial base stations within a geographical region. Here, K may be a positive integer, and the region may refer to, for example, an area having a radius of 500 km centered on a specific point. The representative base stations may receive the interference measurement configuration information from the core network entity.

Each representative base station may, based on the received interference measurement configuration information for triggering interference measurement, start measurement of satellite signals with respect to resource blocks in the satellite signal measurement frequency band at the satellite signal measurement start time, and may measure received signal strengths by performing the configured number of measurements within each period according to the satellite signal measurement period (S401). The received signal strength may be measured as a reference signal received power (RSRP), reference signal received quality (RSRQ), or signal-to-interference-plus-noise ratio (SINR).

Each of the representative base stations may calculate average received signal strengths for the satellite signals measured within the satellite signal measurement period (S402). Each of the representative base stations may compare the calculated average received signal strengths with the interference reporting threshold. Each of the representative base stations may refrain from transmitting information on the average received signal strengths to the core network entity when the calculated average received signal strengths are smaller than the interference reporting threshold. In contrast, each of the representative base stations may transmit information on the average received signal strengths to the core network entity when at least one of the calculated average received signal strengths is equal to or greater than the interference reporting threshold (S403). The core network entity may receive information on the average received signal strengths from at least one representative base station.

Upon receiving information on the average received signal strengths from at least one representative base station, the core network entity may generate measurement configuration information for interference estimation, including a satellite signal measurement frequency band, a satellite signal measurement start time, a satellite signal measurement duration, a number of measurements within a duration, a flag designation condition, and the like. Here, the satellite signal measurement frequency band may be, for example, a frequency band used by terrestrial base stations. The satellite signal measurement start time may be a specific time based on a reference time (e.g. YYYY-MM-DD HH: MM: SS). The satellite signal measurement duration may be, for example, 10 seconds from the measurement start time. The number of measurements within a duration may be, for example, 5. The flag designation condition may include, for example, a flag designation threshold, a flag designation count, and/or similar parameters.

The core network entity may transmit the generated measurement configuration information for interference estimation to a plurality of base stations (base stations 1 to N) located around at least one representative base station. The plurality of base stations may receive the measurement configuration information for interference estimation from the core network entity. Here, N may be a positive integer.

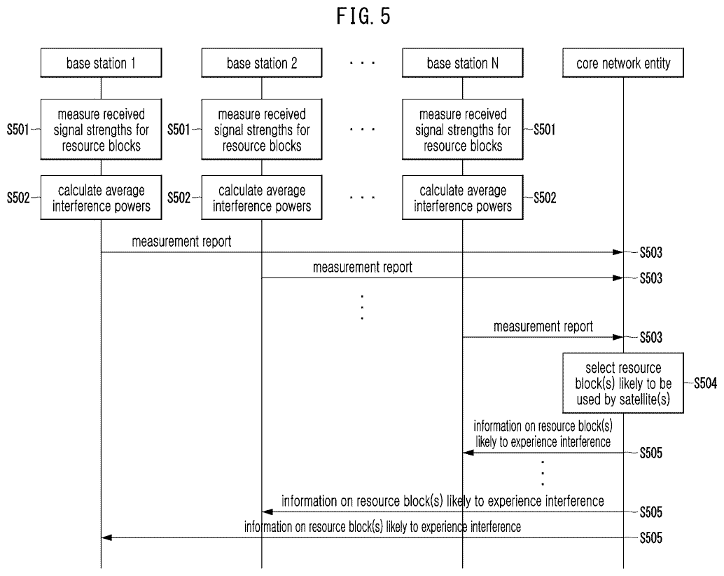

FIG. 5 is a sequence diagram illustrating exemplary embodiments of an interference mitigation method in a communication system.

Referring to FIG. 5, the plurality of base stations (base stations 1 to N) may, according to the measurement configuration information for interference estimation, measure received signal strengths of satellite signals with respect to resource blocks in the satellite signal measurement frequency band, by performing the configured number of measurements within the satellite signal measurement duration starting at the satellite signal measurement start time (S501).

Each resource block may be composed of a time resource block and a frequency resource block. The resource blocks may be allocated according to technical specifications or technical agreements. For example, in a case of a resource allocation type 2 (RAT2) for a shortened time transmission interval (sTTI), the resource blocks may be allocated in a specific manner (e.g. using a specific start granularity or a resource block group (RBG) size) at least partially based on a bandwidth of the communication system.

The plurality of base stations may calculate average values of the measured received signal strengths (S402). Table 4 shows average received signal strength values measured five times during a predetermined duration (e.g. 10 seconds) for a plurality of resource blocks (e.g. seven resource blocks) in the base station 1. The average value may correspond to an average interference power.

TABLE 4

| Resource | | | | | | Average |
|---|---|---|---|---|---|---|
| block | Time 1 | Time 2 | Time 3 | Time 4 | Time 5 | value |
| Resource | 80 | 70 | 80 | 90 | 80 | 80 |
| block 1 | | | | | | |
| Resource | 20 | 30 | 20 | 30 | 20 | 24 |
| block 2 | | | | | | |
| Resource | 30 | 20 | 30 | 20 | 20 | 24 |
| block 3 | | | | | | |
| Resource | 20 | 30 | 30 | 30 | 30 | 28 |
| block 4 | | | | | | |
| Resource | 30 | 40 | 20 | 30 | 30 | 30 |
| block 5 | | | | | | |
| Resource | 40 | 20 | 40 | 30 | 30 | 32 |
| block 6 | | | | | | |
| Resource | 30 | 20 | 40 | 40 | 30 | 32 |
| block 7 | | | | | | |

Table 5 shows average received signal strength values measured five times during a predetermined duration (e.g. 10 seconds) for a plurality of resource blocks (e.g. seven resource blocks) in the base station N. The average value may correspond to an average interference power.

TABLE 5

| Resource | | | | | | Average |
|---|---|---|---|---|---|---|
| block | Time 1 | Time 2 | Time 3 | Time 4 | Time 5 | value |
| Resource | 80 | 70 | 80 | 90 | 80 | 80 |
| block 1 | | | | | | |
| Resource | 20 | 30 | 30 | 30 | 30 | 28 |
| block 2 | | | | | | |
| Resource | 30 | 40 | 20 | 30 | 30 | 30 |
| block 3 | | | | | | |
| Resource | 40 | 20 | 40 | 30 | 30 | 32 |
| block 4 | | | | | | |
| Resource | 30 | 20 | 40 | 40 | 30 | 32 |
| block 5 | | | | | | |
| Resource | 40 | 20 | 40 | 30 | 30 | 32 |
| block 6 | | | | | | |
| Resource | 30 | 20 | 40 | 40 | 30 | 32 |
| block 7 | | | | | | |

Each of the plurality of base stations may designate a flag for a resource block that exhibits interference power higher than the flag designation threshold more times than the flag designation count with respect to the plurality of resource blocks. For example, the base station 1 may designate a flag for a resource block 1 when the flag designation threshold is set to 70 and the flag designation count is set to 3. In addition, the base station N may also designate a flag for the resource block 1 when the flag designation threshold is set to 70 and the flag designation count is set to 3.

Each of the plurality of base stations may transmit a measurement report message including the average interference power calculated for the plurality of resource blocks together with information on the resource blocks to the core network entity (S503).

The core network entity may receive the measurement report messages each including information on the average interference power together with information on the plurality of resource blocks from the plurality of base stations. Alternatively, each of the plurality of base stations may transmit a measurement report message including information on an average interference power calculated for resource block(s) for which a flag is designated together with information on the resource block(s) for which the flag is designated to the core network entity. Then, the core network entity may receive the measurement report messages each including information on the average interference power together with information on the flagged resource block(s) from the plurality of base stations.

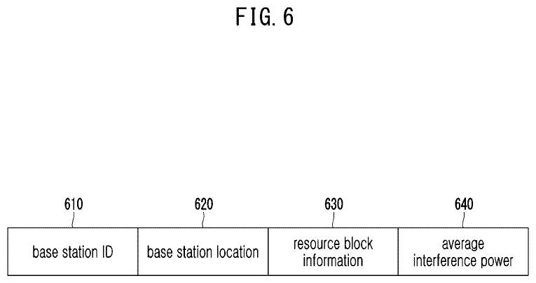

FIG. 6 is a conceptual diagram illustrating a format of a measurement report message. Referring to FIG. 6, the measurement report message may include a base station identifier (ID) field 610, a base station location field 620, a resource block information field 630, an average interference power field 640, and the like. The base station ID field may include an ID of the base station. The base station location field may include geographic location information of the base station. Such geographic location information may include coordinates of the base station. The resource block information field may include information on a time resource block and information on a frequency resource block constituting the resource block. The average interference power field may include information on the average interference power.

Referring again to FIG. 5, the core network entity may acquire base station IDs of the plurality of base stations, location information of the plurality of base stations, information on the resource blocks, and information on the average interference powers for the resource blocks from the measurement report messages received from the base stations.

The core network entity may select at least one resource block that is likely to be used by an NGSO satellite based on the acquired base station IDs, the location information of the plurality of base stations, the information on the resource blocks, and the average interference powers for the resource blocks (S504).

The core network entity may identify average received signal strengths equal to or higher than an interference estimation threshold from the acquired base station IDs, the location information of the plurality of base stations, the information on the resource blocks, and the average received signal strengths for the resource blocks. The core network entity may identify the resource blocks having the identified average received signal strengths. The core network entity may identify a number of base stations having average received signal strengths equal to or higher than the interference estimation threshold for each of the identified resource blocks. The core network entity may estimate resource block(s) having the number of base stations equal to or greater than a threshold number as at least one resource block used by the satellite.

A beam radius of the satellite may be within a range of 100 to 500 km. It may be assumed that an influence of interference received from the satellite on the resource block(s) selected by the core network entity is significantly higher compared to other interference sources.

The core network entity may accurately estimate the at least one resource block used by the NGSO satellite by repeatedly performing steps S501 to S504 several times (e.g. 10 times, 20 times, 30 times, etc.) in cooperation with the base stations 1 to N. The core network entity may transmit information on the at least one resource block estimated to be used by the NGSO satellite to the base stations (S505).

The base stations may receive information on the at least one resource block estimated to be used by the NGSO satellite from the core network entity. The base stations may avoid interference by not using the at least one resource block estimated to be used by the NGSO satellite, which is informed by the core network entity. In this case, communication of the NGSI satellite network itself may be designed by using frequency reuse and the like for interference mitigation. It may be assumed that radio resources allocated to each satellite have a low possibility of changing rapidly.

Meanwhile, the core network entity may associate the flagged radio resources with the locations of base stations. The core network entity may assume that the base station experiencing the strongest interference for the flagged resource block, particularly based on surrounding interference levels, is located at the center of a satellite beam of the NGSO network. The base station receiving the strongest interference for the radio resource used by the NGSO satellite may change as the satellite moves.

The core network entity may accurately estimate at least one resource block used by the NGSO satellite by repeatedly performing steps S501 to S504 several times (e.g. 10 times, 20 times, 30 times, etc.) in cooperation with the base stations 1 to N, and in this case, the core network entity may select base stations having the strongest interference signals based on the estimated resource blocks according to a passage of time. Accordingly, the core network entity may estimate a movement path of the satellite by forming a line connecting the selected base stations receiving the strongest interference in the specific radio resource.

Accordingly, by utilizing trends of information on interferences related to geographic locations, the core network entity may estimate the movement path of the NGSO satellite that uses frequency resources causing interference to terrestrial communication. The core network entity may select base stations expected to be located along the estimated movement path of the NGSO satellite. Then, the core network entity may provide information on the radio resources to the selected base stations.

For the selected base stations, the core network entity may allow steps S501 to S504 to be repeatedly performed. The core network entity may request the selected base stations to measure and report received signal strengths for signals received from the satellite.

In detail, the core network entity may generate measurement configuration information for interference identification, including a satellite signal measurement frequency band, a satellite signal measurement start time, a satellite signal measurement duration, and a number of measurements within a duration. Here, the satellite signal measurement frequency band may be, for example, a frequency band corresponding to resource blocks estimated to cause interference. The satellite signal measurement start time may be a specific time based on a reference time (e.g., YYYY-MM-DD HH: MM: SS). The satellite signal measurement duration may be, for example, 10 seconds from the measurement start time, and the number of measurements within the duration may be, for example, 5.

The core network entity may transmit the generated measurement configuration information for interference identification to base stations (base stations 1 to M) expected to be located along the movement path of the satellite. The base stations may receive the measurement configuration information for interference identification from the core network entity. Here, M may be a positive integer.

According to the measurement configuration information, the plurality of base stations may measure received signal strength values of satellite signals for resource blocks estimated to cause interference within the satellite signal measurement frequency band by performing the configured number of measurements within the satellite signal measurement duration starting at the satellite signal measurement start time. The plurality of base stations may then calculate average received signal strength values.

Each base station may transmit a measurement report message including an average interference power calculated for the plurality of resource blocks, together with information on the resource blocks, to the core network entity. The core network entity may receive the measurement report message including the average interference power and the information on the resource blocks expected to cause interference from each of the plurality of base stations.

The core network entity may acquire base station IDs of the plurality of base stations, location information of the plurality of base stations, information on the resource blocks, and the average interference powers for the resource blocks from the measurement report messages received from the base stations.

The core network entity may determine whether each base station is located along the movement path of the NGSO satellite based on the acquired base station IDs, the location information of the plurality of base stations, the resource-block information, and the corresponding average interference powers. When a particular base station is determined not to be located along the movement path, the core network entity may request the base station to stop an interference avoidance operation. Upon receiving the request to stop the interference avoidance operation, the base station may provide services to terminals by using the radio resources that had been expected to cause interference.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a core network entity, the method comprising:
generating first measurement configuration information for resource blocks predicted to be used by a satellite;
transmitting the first measurement configuration information to a plurality of base stations;
receiving first measurement results from the plurality of base stations, the first measurement results being measured for the resource blocks according to the first measurement configuration information; and
estimating at least one resource block used by the satellite based on the received first measurement results.

2. The method of claim 1, wherein the first measurement configuration information includes at least one of: information on a measurement frequency band of satellite signals of the satellite, information on a measurement start time of the satellite signals, information on a measurement duration of the satellite signals, information on a number of measurements within the measurement duration, or a flag designation condition.

3. The method of claim 1, wherein each of the first measurement results includes an average received signal strength obtained by averaging received signal strengths measured by each of the plurality of base stations for each of the resource blocks at a predetermined time and with a predetermined number of measurements.

4. The method of claim 1, further comprising, before the generating of the first measurement configuration information,
generating second measurement configuration information for the resource blocks predicted to be used by the satellite;
transmitting the second measurement configuration information to a representative base station representing the plurality of base stations; and
receiving a second measurement result from the representative base station, the second measurement result being measured for the resource blocks according to the second measurement configuration information.

5. The method of claim 4, wherein the second measurement configuration information includes at least one of: information on a measurement frequency band of satellite signals of the satellite, information on a measurement start time of the satellite signals, information on a measurement period of the satellite signals, information on a number of measurements in the measurement period, or an interference reporting threshold.

6. The method of claim 1, wherein the estimating of the at least one resource block comprises:
identifying average received signal strengths equal to or greater than an interference estimation threshold from among average received signal strengths included in the received first measurement results;
identifying resource blocks corresponding to the identified average received signal strengths;
identifying, for each of the identified resource blocks, a number of base stations having average received signal strengths equal to or greater than the interference estimation threshold; and
estimating, as the at least one resource block used by the satellite, a resource block for which the number of base stations is equal to or greater than a threshold number.

7. The method of claim 1, further comprising: transmitting information on the at least one resource block used by the satellite to the plurality of base stations.

8. The method of claim 1, further comprising:
identifying a movement path of the satellite based on the at least one resource block used by the satellite; and
transmitting information on the at least one resource block to base stations located along the identified movement path.

9. The method of claim 8, further comprising:
generating third measurement configuration information for the at least one resource block;
transmitting the third measurement configuration information to the base stations located along the movement path;
receiving third measurement results from the base stations located along the movement path, the third measurement results being measured for the at least one resource block according to the third measurement configuration information;
identifying, based on the received third measurement results, at least one base station located outside the movement path; and
instructing the at least one base station to use the at least one resource block.

10. A method of a base station, the method comprising:
receiving, from a core network entity, first measurement configuration information for resource blocks predicted to be used by a satellite;
performing measurement on the resource blocks predicted to be used by the satellite according to the first measurement configuration information; and
transmitting a measurement result obtained from the measurement to the core network entity.

11. The method of claim 10, wherein the first measurement configuration information includes at least one of: information on a measurement frequency band of satellite signals of the satellite, information on a measurement start time of the satellite signals, information on a measurement duration of the satellite signals, information on a number of measurements within the measurement duration, or a flag designation condition.

12. The method of claim 10, wherein each of the first measurement results includes an average received signal strength obtained by averaging received signal strengths measured by each of the plurality of base stations for each of the resource blocks at a predetermined time and with a predetermined number of measurements.

13. The method of claim 10, further comprising, based on the base station being a representative base station representing a plurality of base stations located nearby, before the receiving of the first measurement configuration information,
receiving, from the core network entity, second measurement configuration information for the resource blocks predicted to be used by the satellite;
performing measurement on the resource blocks predicted to be used by the satellite according to the second measurement configuration information; and
transmitting a second measurement result obtained from the measurement to the core network entity.

14. The method of claim 13, wherein the second measurement configuration information includes at least one of: information on a measurement frequency band of satellite signals of the satellite, information on a measurement start time of the satellite signals, information on a measurement period of the satellite signals, information on a number of measurements in the measurement period, or an interference reporting threshold.

15. The method of claim 10, further comprising: receiving, from the core network entity, information on at least one resource block used by the satellite.

16. The method of claim 15, further comprising:
receiving, from the core network entity, third measurement configuration information for the at least one resource block;
performing measurement on the at least one resource block used by the satellite according to the third measurement configuration information; and
transmitting a third measurement result obtained from the measurement to the core network entity.

17. A base station comprising at least one processor, wherein the at least one processor causes the base station to perform:
receiving, from a core network entity, first measurement configuration information for resource blocks predicted to be used by a satellite;
performing measurement on the resource blocks predicted to be used by the satellite according to the first measurement configuration information; and
transmitting a measurement result obtained from the measurement to the core network entity.

18. The base station of claim 17, wherein based on the base station being a representative base station representing a plurality of base stations located nearby, the at least one processor causes the base station to perform, before the receiving of the first measurement configuration information,
receiving, from the core network entity, second measurement configuration information for the resource blocks predicted to be used by the satellite;
performing measurement on the resource blocks predicted to be used by the satellite according to the second measurement configuration information; and
transmitting a second measurement result obtained from the measurement to the core network entity.

19. The base station of claim 17, wherein the at least one processor further causes the base station to perform: receiving, from the core network entity, information on at least one resource block used by the satellite.

20. The base station of claim 17, wherein the at least one processor further causes the base station to perform:
receiving, from the core network entity, third measurement configuration information for the at least one resource block;
performing measurement on the at least one resource block used by the satellite according to the third measurement configuration information; and
transmitting a third measurement result obtained from the measurement to the core network entity.
